(19) United States
(12) Patent Application Publication
(10) Pub. No.: US 2026/0104563 A1
(43) Pub. Date: Apr. 16, 2026

(54) OPTICAL FIBER CABLE SUITABLE FOR INDOOR AND OUTDOOR USE AND DUCT INSTALLATION

(71) Applicant: CORNING RESEARCH & DEVELOPMENT CORPORATION, Corning, NY (US)

(72) Inventors: William Carl Hurley, Hickory, NC (US); Toua Lo, Hickory, NC (US); William Welch McCollough, JR., Lincolnton, NC (US); Peter Stuart Niehoff, Connelly Springs, NC (US)

(21) Appl. No.: 19/422,878

(22) Filed: Dec. 17, 2025

Related U.S. Application Data
(63) Continuation of application No. PCT/US2024/034428, filed on Jun. 18, 2024.
(60) Provisional application No. 63/522,891, filed on Jun. 23, 2023.

(51) Int. Cl. G02B 6/44

(52) U.S. Cl. CPC G02B 6/4433; G02B 6/4403; G02B 6/4431; G02B 6/44384; G02B 6/4486

(57) ABSTRACT

An optical fiber cable includes a cable jacket, a strength member embedded in the jacket, a thin-film subunit (TSU), and a first water-blocking element. The first water-blocking element is disposed in a first interior region defined by the cable jacket between an interior surface of the cable jacket and the TSU, such that the TSU does not tack to the cable jacket during extrusion of the cable jacket. The cable can further include one or more strength elements disposed in the first interior region. The TSU has an optical fiber ribbon disposed therein. The TSU can further include a ripcord and/or second water-blocking elements disposed therein.

### RELATED APPLICATIONS

This application is a continuation of Internation Patent Application No. PCT/US2024/034428, filed on Jun. 18, 2024, which claims priority to U.S. Provisional Patent Application No. 63/522,891, filed on Jun. 23, 2023, and entitled “OPTICAL FIBER CABLE SUITABLE FOR INDOOR AND OUTDOOR USE AND DUCT INSTALLATION”, the entirety of which is incorporated herein by reference.

### BACKGROUND

Optical fiber cables are configured to carry optical signals having high bandwidth and low loss over long distances. Conventionally, optical fiber cables have been configured for highly specific deployments. For example, cables for outdoor use have been configured differently from cables for indoor use, cables for aerial installation have been configured differently from cables for duct installation, and cables for duct installation have been configured differently depending on whether they are intended to be pulled through a duct or jetted/blown through a duct.

### SUMMARY

The following is a brief summary of subject matter that is described in greater detail herein. This summary is not intended to be limiting as to the scope of the claims.

Various technologies pertaining to an optical fiber cable that is suitable for indoor and outdoor use and is further suitable for duct installation by pulling and/or jetting/blowing are described herein. An exemplary optical fiber cable includes a cable jacket that extends longitudinally along a length of the cable. The cable jacket surrounds a first interior region that is defined by an interior surface of the cable jacket, wherein the first interior region extends along the length of the cable. The cable includes one or more strength members that are embedded in the cable jacket and that also extend along the length of the cable. Within the first interior region is disposed a cable core that includes a thin-film subunit (TSU), a separation element, and a flexible optical fiber ribbon. The TSU comprises an extruded polymer element that extends longitudinally within the first interior region. The TSU has an interior surface and an exterior surface. The interior surface of the TSU defines a second interior region that is disposed within the TSU. The flexible optical fiber ribbon is disposed within the second interior region, such that the TSU surrounds the flexible optical fiber ribbon. The separation element is disposed between the TSU and the interior surface of the cable jacket. The separation element is positioned such that no portion of the TSU is in direct contact with the interior surface of the cable jacket. The cable can further include additional strength elements that are disposed within the first interior region.

The above summary presents a simplified summary in order to provide a basic understanding of some aspects of the systems and/or methods discussed herein. This summary is not an extensive overview of the systems and/or methods discussed herein. It is not intended to identify key or critical elements or to delineate the scope of such systems and/or methods. Its sole purpose is to present some concepts in a simplified form as a prelude to the more detailed description that is presented later.

### BRIEF DESCRIPTION OF THE DRAWINGS

The accompanying drawings are included to provide a further understanding and are incorporated in and constitute a part of this specification. The drawings illustrate one or more embodiments, and together with the description serve to explain principles and operation of the various embodiments.

FIG. 1A depicts a perspective view of an exemplary optical fiber cable;

FIG. 1B depicts a cross-sectional view of the exemplary optical fiber cable of FIG. 1A;

FIG. 2 depicts a cross-sectional view of another exemplary optical fiber cable;

FIG. 3 depicts a cross-sectional view of yet another exemplary optical fiber cable;

FIG. 4 depicts a cross-sectional view of still another exemplary optical fiber cable;

FIG. 5 depicts a cross-sectional view of still yet another exemplary optical fiber cable;

FIG. 6 depicts a cross-sectional view of a further exemplary optical fiber cable;

FIG. 7 is a flow diagram that illustrates an exemplary methodology for making an optical fiber cable.

### DETAILED DESCRIPTION

Various technologies pertaining to optical fiber cables suitable for indoor/outdoor use and pulling or jetting through ducts are described herein. With more particularity, technologies pertaining to optical fiber cables that are configured to facilitate routing of optical fiber ribbons to different locations in a splice tray are described herein. Such technologies are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices may be shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Additionally, as used herein, the term “exemplary” is intended to mean serving as an illustration or example of something, and is not intended to indicate a preference.

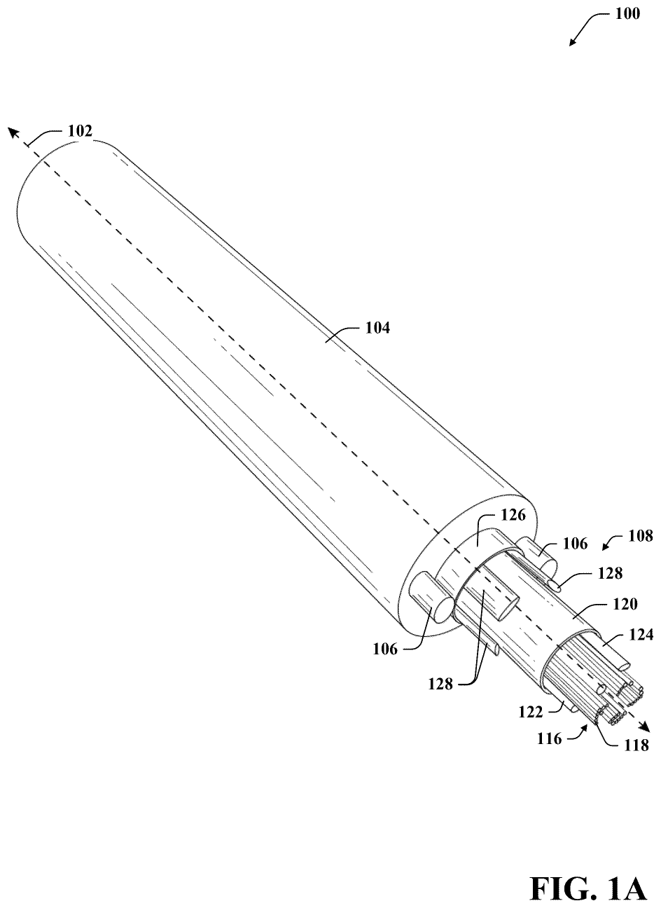

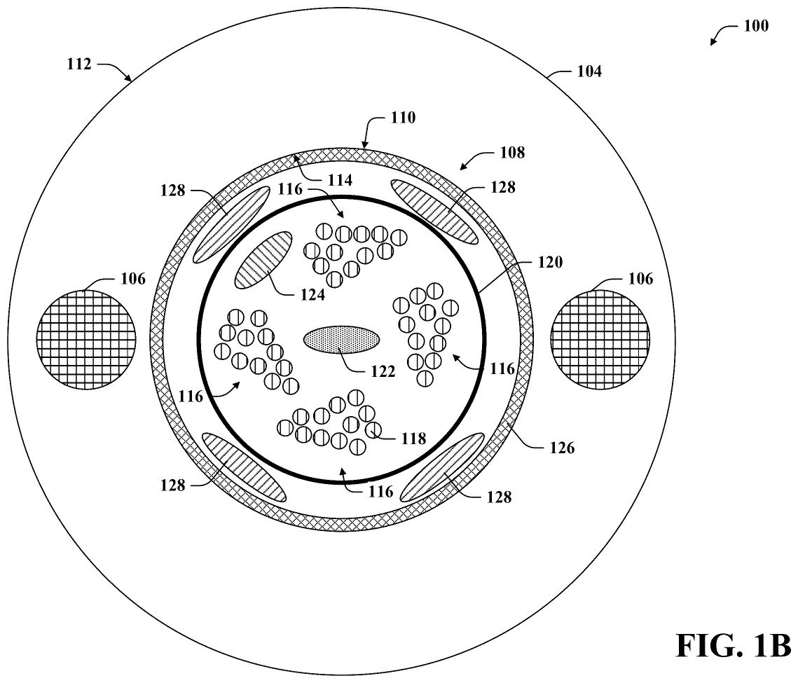

With reference now to FIGS. 1A-1B, an exemplary optical fiber cable 100 is illustrated. Referring now solely to FIG. 1A, a perspective view of the exemplary optical fiber cable 100 is shown, wherein the cable 100 extends longitudinally along a first direction 102. Referring now solely to FIG. 1B, a cross-sectional view of the optical fiber cable 100 is shown, wherein the cross-sectional view looks along the first direction 102.

Referring again to FIGS. 1A and 1B, the cable 100 includes a cable jacket 104, one or more strength elements 106 embedded in the cable jacket 104, and a cable core 108 that is disposed within an interior region 110 defined by the cable jacket 104. The cable jacket 104 extends longitudinally along the first direction 102. The cable jacket 104 has an outside surface 112 that defines an exterior surface of the cable 100. The cable jacket 104 further has an interior surface 114 that defines the interior region 110 within which the cable core 108 is disposed. Stated differently, the cable jacket 104 forms an exterior of the cable 100 and surrounds the cable core 108.

The cable jacket 104 can be formed of any of various extrudable materials such as, but not limited to, a single polymer or a blend of polymers selected from the following non-limiting list: ethylene-vinyl acetate copolymers, ethylene-acrylate copolymers, ethylene homopolymers (including but not limited to low density, medium density, and high density), linear low density polyethylene (LLDPE), very low density polyethylene, polyolefin elastomer copolymer, propylene homopolymer, polyethylene-polypropylene copolymer, butene- and octene branched copolymers, polyester copolymers, polyethylene terephthalates, polybutylene terephthalates, other polymeric terephthalates, and maleic anhydride-grafted versions of the polymers listed herein.

In various exemplary embodiments, the cable jacket 104 comprises a fire-retardant material such as metal hydrates and/or metal hydroxides, such as aluminum trihydrate (ATH) and/or magnesium dihydroxide (MDH), borates, and/or other suitable materials that are often referred to as low smoke, zero halogen (LSZH) materials; fire retarded, non-corrosive (FRNC) materials; or fire retarded polyethylene (FRPE) materials. In various embodiments, the cable jacket 104 can comprise a blend of a polyolefin, a fire retardant, and a UV stabilizer. In some embodiments, the cable jacket 104 can include a lubricant material to facilitate pulling and/or jetting of the cable 100 through a duct. The cable jacket 104 can be configured to have a low coefficient of friction (CoF) with respect to a polyethylene duct in order to enable good jetting and pulling performance. For example, the cable jacket 104 can be configured such that the dynamic CoF of the cable 100 sliding in a polyethylene duct can be ≤0.10. In other embodiments, the cable jacket 104 can be configured such that the dynamic CoF of the cable 100 sliding in a polyethylene duct can be ≤0.07. The cable jacket 104 can be formed of a material that contains one or more fire retardants sufficient in quantity and type to pass the UL 1666, UL 1685 and EN 50399 burn tests. The fire-retardant properties of the material of the cable jacket 104 can be measured in a cone calorimetry test with a heat flux of 50 kW/m². When so tested, the material used to form the cable jacket 104 can be selected to have a peak heat release rate of <240 kW/m², or <200 kW/m². The material used to form the cable jacket 104 can be configured such that the total heat release during the cone calorimetry test described above is <70 MJ/m², or <62 MJ/m². The material used to form the cable jacket 104 can be configured such that the total smoke release during the test is <1100 m²/m², or <600 m²/m².

In exemplary embodiments, the strength elements 106 comprise fiberglass yarns. Such embodiments may be well-suited to temperature-controlled environments (e.g., indoors) where temperature-dependent jacket shrinkage is less significant than temperature-varying environments. In other embodiments, the strength elements 106 comprise glass-reinforced plastic (GRP) rods. These embodiments may be suited to outdoor environments that experience large variations in temperature. The use of GRP rods as the strength elements 106 can inhibit temperature-induced shrinkage of the cable jacket 104, which shrinkage can cause buckling of optical fibers in the cable core 108, thereby causing attenuation of optical signals carried by the optical fibers. However, the use of these GRP rods can also cause the cable 100 to exhibit preferential bending, which may be unsuitable for use in indoor environments where smaller bending radii may be desirable for purpose of cable routing. In various embodiments, the strength elements 106 can comprise fiberglass yarns, and a free space in the interior region 110 (i.e., a fraction of the cross-sectional area of the interior region 110 looking down the length of the cable 100 that is void space, unoccupied by components of the cable 100) can be increased relative to embodiments wherein the strength elements 106 comprise GRP rods. In exemplary embodiments wherein the strength elements 106 comprise fiberglass yarns, the free space can be greater than or equal to 60%, or greater than or equal to 47%. Those skilled in the art will appreciate that there are trade-offs in the cable design. All else being equal, greater free space tends to yield less optical signal loss at low temperatures but results in a larger cable. Similarly, lower free space tends to yield smaller cable size but more optical signal loss. Thus, the free space is adjusted to simultaneously meet the requirements of both cable size and signal loss. The exemplary cable 100 shown in FIGS. 1A-1B includes a plurality of two strength elements 106, but it is to be understood that the jacket 100 can have substantially any number of strength elements 106 disposed therein. As will be described in greater detail below, the cable 100 can include additional strength elements elsewhere in the cable. Generally, the cable jacket 104 can be configured to have an elastic modulus >300 MPa at room temperature (e.g., between about 65 degrees Fahrenheit and about 75 degrees Fahrenheit), or >800 Mpa at room temperature, in order to give the cable 100 enough stiffness to suitably jet through a duct.

The cable core 108 comprises one or more flexible optical fiber ribbons 116. The flexible optical fiber ribbons 116 each comprise a plurality of optical fibers 118 that are intermittently bonded to one another to form the flexible optical fiber ribbons 116. The optical fiber ribbons 116 are flexible in that they are able to be rolled or folded while the optical fibers 118 included therein remain bonded to one another. Thus, the flexible optical fiber ribbons in 116 can be rolled or folded to occupy less space in the cable 100 than a comparable number of conventional planar ribbons, while the optical fibers 118 remain bonded to one another to provide organization of the fibers 118 into groups.

The flexible optical fiber ribbons 116 can be configured as duplex ribbons. In other words, the ribbons 116 can be configured such that pairs of the optical fibers 118 within a ribbon are bonded together by a matrix material along a length of the ribbon, and then each of these bonded pairs is intermittently bonded to at least one other bonded pair in the ribbon. Such duplex ribbons can facilitate routing of pairs of optical fibers, such as to duplex connectors that are configured to receive and connectorize pairs of optical fibers.

In exemplary embodiments, the flexible optical fiber ribbons 116 can each comprise a plurality of 12 fibers. A number of the flexible optical fiber ribbons 116 can depend on an intended application for the cable 100. In non-limiting examples, a total number of optical fibers of the flexible optical fiber ribbons 116 can be greater than or equal to 12 and less than or equal to 288 fibers.

While the exemplary cables describe herein are described as including flexible optical fiber ribbons (e.g., the ribbons 116), it is to be understood that such ribbons can instead be conventional rigid, planar optical fiber ribbons. For instance, the optical fibers 118 in the cable 100 can instead be arranged in ribbon stacks. In other exemplary embodiments, the optical fibers 118 can be loose fibers. In such embodiments, the optical fibers 118 may, in addition to coloration of the individual fibers 118, include ring marking to further facilitate fiber identification.

The flexible optical fiber ribbons 116 are disposed within a thin-film subunit (TSU) 120. The TSU 120 is formed by an extruded polymer element that extends longitudinally along a length of the cable 100. The TSU 120 can be formed as a tube such that the TSU 120 surrounds the ribbons 116, such that the ribbons 116 are contained within the TSU 120. In a non-limiting example, the TSU 120 is formed as an extruded layer of a polyolefin. With greater particularity, the TSU 120 may be formed from an extruded layer of linear low density polyethylene (LLDPE) or low density polyethylene (LDPE). The TSU 120 is sufficiently flexible that the cable jacket 104 and other elements of the cable core 108 can be stripped away from the TSU 120 and the TSU 120 independently routed, such as into a splice tray, to facilitate splicing or other operations with respect to the ribbons 116 by an installer in the field. The TSU 120 is also flexible enough that, when the cable 100 is bent, the TSU 120 can be pushed aside by the ribbons 116 inside. Thus, when the cable 100 is bent or stressed, the TSU 120 allows the ribbons 116 to move to lower-stress positions, preventing damage to or attenuation in the optical fibers 118. Still further, the TSU 120 can provide containment to the ribbons to prevent the optical fibers 118 from snagging on portions of a splice tray, which snagging can otherwise break the optical fibers 118.

In exemplary embodiments, the extruded polymer element that forms the TSU 120 has a thickness of less than or equal to 100 microns. With greater particularity, the extruded polymer element that forms the TSU 120 can have a thickness of greater than or equal to 30 microns and less than or equal to 100 microns. In still further embodiments, the extruded polymer element that forms the TSU 120 can have a thickness of greater than or equal to 40 microns and less than or equal to 60 microns.

The TSU 120 can have one or more water-blocking elements disposed therein. By way of example, and not limitation, the TSU 120 can have one or more water-blocking yarns 122 disposed therein. In some embodiments, one of the yarns 122 can be a central yarn around which the ribbons 116 are stranded (e.g., in a helical or S-Z stranding pattern). In other embodiments, the ribbons 116 can extend along a length of the cable 100 in a substantially parallel fashion (i.e., not stranded). Stranding of the ribbons (e.g., around the central yarn) can improve attenuation performance of the optical fiber cable 100. However, it may be less expensive to manufacture the cable 100 if the ribbons 116 are disposed in a substantially parallel manner, due to increased manufacturing line speeds or the ability to dispense with expensive and bulky stranding machinery. In other embodiments, as described in greater detail below, the one or more water-blocking elements disposed in the TSU 120 can be or include a water-swellable powder. Such a powder can be disposed on or embedded in an interior surface of the TSU 120.

In some embodiments, cable core 108 includes a ripcord 124 that is disposed within the TSU 120. When pulled, the ripcord 124 tears the TSU 120, exposing the components inside. Thus, the ripcord 124 provides a means by which an installer of the cable 100 can access the ribbons 116 disposed within the TSU 120. It is to be appreciated, however, that in at least some embodiments, the TSU 120 may be configured to be tearable by hand or by various tools, and the ripcord 124 can be omitted. In various embodiments, the ripcord 124 can have a water-blocking material (e.g., a water-absorbing powder) applied thereto.

The cable core 108 can further comprise a water-blocking element 126 that is disposed between an outer surface of the TSU 120 and the interior surface 114 of the cable jacket 104, such that no portion of the TSU 120 is in contact with the cable jacket 104. By way of example, the water-blocking element 126 is shown in the cable 100 as a water-blocking tape 126. The water-blocking tape 126 can be adhered to the interior surface 114 of the cable jacket 104 such that the water-blocking tape 126 is substantially conformal to the interior surface 114 of the cable jacket 104. The water-blocking tape 126 provides protection from water intrusion throughout the length of the cable 100. Furthermore, the water-blocking tape 126 can protect the TSU 120 from being adhered to the cable jacket 104 during manufacturing. For instance, the cable 100 can be formed by extruding the cable jacket 104 around the cable core 108. A polymeric material from which the cable jacket 104 is formed generally is heated to allow the material to be extruded. In the absence of the water-blocking tape 126, the hot cable jacket 104 could cause tacking of the TSU 120 to the interior surface 114. The water-blocking tape 126 can be configured to withstand temperatures needed to extrude the material from which the cable jacket 104 is formed. For example, the water-blocking tape 126 can be configured to resist melting up to at least 300-, 350-, or 410-degrees Fahrenheit.

As indicated above, the cable core 108 can further include one or more additional strength elements 128 that are disposed between the water-blocking element 126 and the TSU 120. In exemplary embodiments, the strength elements 128 can be or include tensile yarns such as aramid, fiberglass, or other high modulus yarns. In embodiments, the strength elements 128 can be a plurality of four 3220 dtex aramid yarns. Such yarns can provide sufficient tensile strength to the cable 100 to allow the cable 100 to be pulled into a duct and to meet a 300-lb tensile requirement for a lightweight outdoor cable. These yarns can further provide protection to the ribbons 116 against crush loads applied to the cable 100. In the absence of the TSU 120, such yarns have the potential to become entangled with the flexible ribbons 116. When so-entangled, these yarns can stress and break the optical fibers 118 when a tensile load is applied to the cable 100 (e.g., when pulling the cable 100 into a duct). The TSU 120 prevents such entanglement of yarn strength elements 128 with flexible optical fiber ribbons 116.

The strength yarns 128 can be disposed longitudinally within the cable 100, as opposed to being stranded. This facilitates movement of the strength yarns 128 within the cable 100 as the cable 100 experiences locally applied loads during installation and use. For instance, when the cable 100 is pulled around a bend during installation, the strength yarns 128 may be pulled to the inside of the bend.

The configuration of the cable 100 facilitates inclusion of additional strength elements 128 (e.g., additional tensile yarns) or removal of one or all of the strength elements 128 based upon a tensile strength requirement for a particular cable application. Further, a free space within the interior region 110 of the cable 100 can be adjusted to ensure sufficient space for a number of the strength elements 128 needed for a desired tensile strength requirement of the cable 100. Certain strength requirements are specified in standards such as ICEA S-104-696-2019 for indoor-outdoor cables or ANSI/ICEA S-122-744-2016 for micro duct cables. Common tensile requirements are 100-lb, 150-lb, 300-lb, and 600-lb depending on the specific application. Such strength requirements define a rated load up to which a strain on the optical fibers of an optical fiber cable is less than or equal to 0.60%.

In various embodiments, the cable 100 is configured such that the strength elements 106 that are embedded in the jacket 104 are selected and sized so as to limit thermal shrinkage of the jacket 104, rather than to provide the necessary strength to meet a tensile load requirement for the cable 100. For example, the inventors have identified that a conventional cable having jacket-embedded strength elements would require four 1.25 mm diameter GRP rods to provide sufficient tensile strength to meet a 300-lb tensile load requirement. By contrast, an exemplary embodiment of the inventive cable 100 can satisfy a 300-lb tensile load requirement using four 0.70 mm GRP rods as the jacket-embedded strength members 106 by employing the strength elements 128 (such as aramid yarns) between the TSU 120 and the water-blocking tape 126. Accordingly, the strength members 106 of the cable 100 can be smaller than those of conventional cables, allowing the cable 100 to have a smaller diameter (thereby improving fiber density in cable installations) and greater flexibility (thereby enhancing the ease of installation and reducing preferential bending associated with conventional cables).

In exemplary embodiments, a size and number of the strength elements 106 used to limit thermal shrinkage of the jacket 104 can be determined based upon a contraction strain of the cable 100. A cable contraction strain resulting from a temperature change ΔT can be calculated according to the following equation:

$$Strain = \frac{{\sum }_{i} {E}_{i} {A}_{i} {α}_{i} Δ T}{{\sum }_{i} {E}_{i} {A}_{i}} \qquad Eq . 1$$

where Eᵢ, Aᵢ, αᵢ are the elastic modulus, the cross-sectional area, and the coefficient of thermal expansion, respectively, of each of the components of a cable. In computing a contraction strain of the cable 100, contributions of the water-blocking yarns 122, the ripcord 124, the water-blocking tape 126, and additional strength elements 128 are typically omitted from the calculation as these elements have substantially no compressive strength. Similarly, in embodiments wherein a corrugated or roll-formed armor layer (not illustrated) is included in the cable 100, such layers may be omitted from the calculation of Eq. 1 as they are designed to be flexible and contribute little to the contraction resistance of the cable 100. Further, the optical fibers 118 themselves can be excluded from the calculation of Eq. 1 since the cable 100 is constructed to have free space allowing the fibers 118 to buckle as the cable 100 contracts (as opposed to resisting contraction of the cable 100). Accordingly, determination of contraction strain of a cable according to Eq. 1 typically considers a cable jacket, any subunits (e.g., the extruded polymer element of the TSU 120), any buffer tubes, tight buffer material around any of the fibers of the cable, jacket-embedded strength elements (such as, but not limited to, GRPs, embedded yarns, aramid-reinforced plastic rods, metal wires), and any overcoating that may be present on such embedded strength elements.

It is to be appreciated by those of skill in the art that the elastic modulus of plastic elements of a cable is neither constant nor linear with temperature change. Furthermore, the elastic modulus changes with the rate of shear, and there is stress relaxation that occurs in plastic elements over time. In order to compensate for these and other unknowns, the inventors have observed that satisfactory calculations of the contraction strain are obtained by employing an estimated elastic modulus value for plastic elements of a cable. Such estimated elastic modulus of an element can be determined by measuring the modulus using a dynamic mechanical analyzer (DMA) and multiplying by a correction factor of 0.50.

In exemplary embodiments, a size, number, and composition of the strength elements 106 of the cable 100 are selected to provide, for a given construction of the remaining elements of the cable 100, a contraction strain that is below a threshold contraction strain. For example, the strength elements 106 of the cable 100 can be configured to yield a calculated strain, according to Eq. 1 and its accompanying description above, of less than or equal to 0.25% for a cable that is employed in an outdoor installation. In other embodiments, the strength elements 106 can be configured to yield a calculated cable strain for an outdoor installation of 0.20% or less. By way of further example, the strength elements 106 of the cable 100 can be configured to yield a calculated strain of less than or equal to 0.40% for a cable that is employed in an indoor installation.

Once the strength elements 106 of the cable 100 have been selected, a number and composition of the additional strength elements 128 that are disposed within the cable core 108 can be selected to provide a desired tensile strength rating of the cable 100.

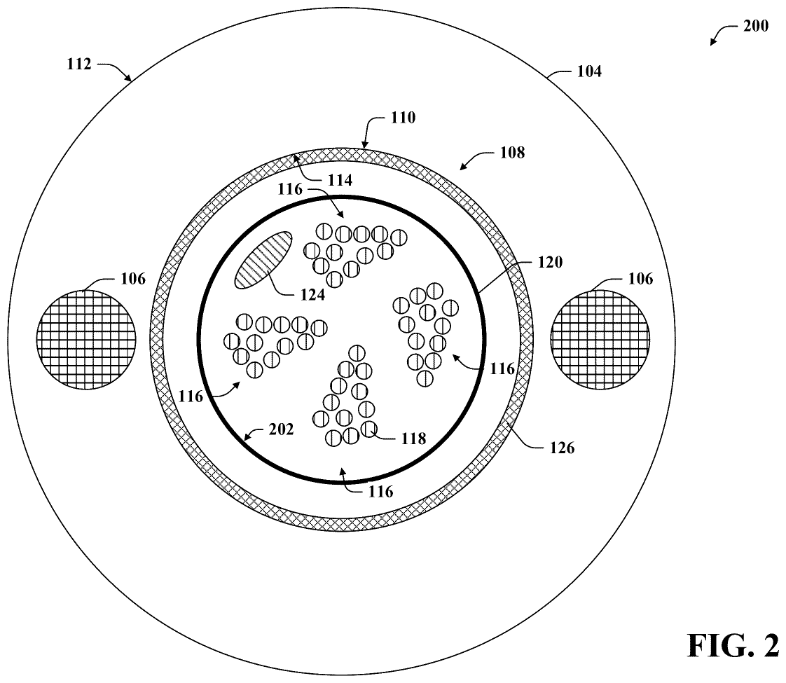

Various modifications to the cable 100 depicted in FIGS. 1A-1B are contemplated as being within the scope of the present disclosure, and are described in greater detail with respect to FIGS. 2-5. However, it is to be understood that such modifications do not constitute an exhaustive recitation of embodiments that are considered part of the invention describe herein. For example, while not depicted in FIGS. 1-5, it is to be appreciated that a ripcord can be positioned in the interior region 110 defined by the cable jacket 104 in order to facilitate opening of the cable jacket 104 to provide access to the cable core 108 (e.g., by an installer in the field). By way of another example, while not depicted in FIGS. 1-5, it is to be appreciated that the TSU 120 can be replaced by a binder thread or yarn that bundles the ribbons 116 together. In a still further example, in some embodiments of the cable 100 intended for indoor-only development, the water-blocking tape 126 can be omitted. In such embodiments, material used to form the cable jacket 104 and the TSU 120 are selected to avoid sticking of the TSU 120 to the cable jacket 104. For example, the cable jacket 104 can comprise fire-resistant polyvinyl chloride (PVC), and the TSU 120 can be formed of a polyethylene.

Referring now to FIG. 2, another exemplary optical fiber cable 200 is shown. The cable 200 includes the cable jacket 104, the embedded strength elements 106, the water-blocking tape 126, the TSU 120, the optical fiber ribbons 116, and the ripcord 124. The cable 200 omits the additional strength elements 128 disposed between the TSU 120 and the water-blocking tape 126. The cable 200 can be employed in applications where the cable 200 will be blown or jetted through a duct rather than pulled, thereby requiring less tensile strength than is generally needed to resist the tensile load on the cable 200 that would result from pulling the cable 200. In the exemplary cable 200, an interior surface 202 of the TSU 120 can have a water-blocking material, such as a superabsorbent polymer (SAP) powder, applied thereto. Thus, the cable 200 can omit the water-blocking yarns 122 of the cable 100 while retaining the ability to prevent water intrusion/migration in the TSU 120.

In various exemplary embodiments, a water blocking powder can be applied to an inside surface of the cable jacket 104 as a separation layer to prevent the TSU 120 from tacking to the jacket 104 during manufacturing of the cable. In such embodiments, the water-blocking tape 126 may further be omitted from the cable 100 or the cable 200.

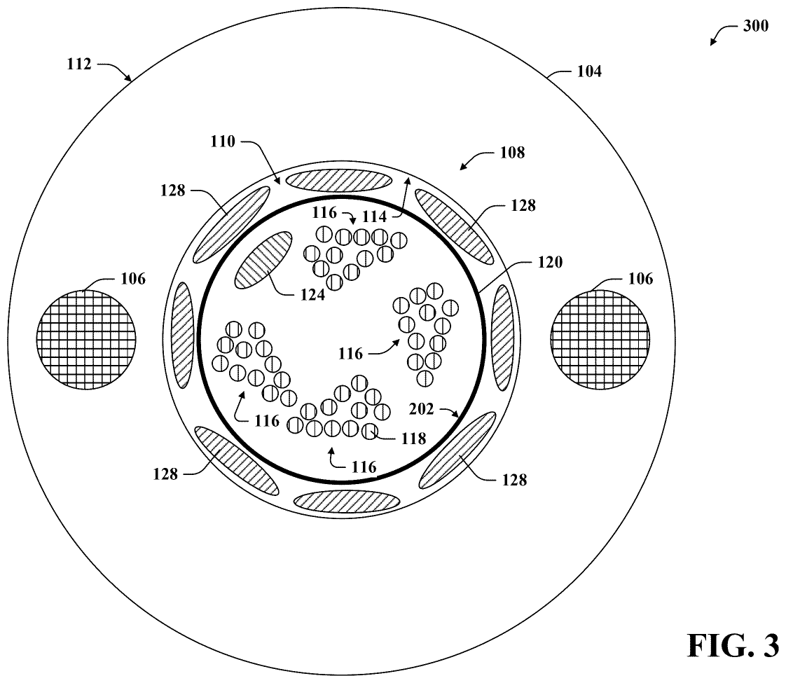

Referring now to FIG. 3, still another exemplary optical fiber cable 300 is shown. The cable 300 includes the cable jacket 104, the embedded strength elements 106, the strength elements 128, the TSU 120, and the optical fiber ribbons 116 and ripcord 124 disposed within the TSU 120. Like the cable 200, the cable 300 can omit the water-blocking yarns 122 disposed in the TSU 120, and can instead have a water-blocking material applied to the interior surface 202 of the TSU 120 to prevent water intrusion/migration.

The cable 300 can further omit the water-blocking tape 126. Instead, the cable 300 can include a plurality of additional strength elements 128 disposed between the TSU 120 and the interior surface 114 of the cable jacket 104. One or more of the strength elements 128 can have a water-blocking material (e.g., SAP powder) applied thereto, such that the strength elements 128 collectively act as a water-blocking element. A number of the strength elements 128 can further be sufficiently high to form a separation layer so that no portion of the TSU 120 makes contact with the interior surface 114 of the cable jacket 104. Thus, even without the water-blocking tape 126, the strength elements 128 surround the TSU 120 and prevent the TSU 120 from tacking to the interior surface 114 of the cable jacket 104 as the jacket 104 is extruded around the TSU 120 and the strength elements 128. The cable 300 is well-suited to embodiments wherein a tensile strength requirement of the cable 300 is high. A number of the strength elements 128 needed to meet the tensile strength requirement of the cable 300 may be sufficiently high that the strength elements 128 prevent the TSU 120 from making contact with the interior surface 114 of the cable jacket 104. In such embodiments, inclusion of the water-blocking tape 126 may be unnecessary.

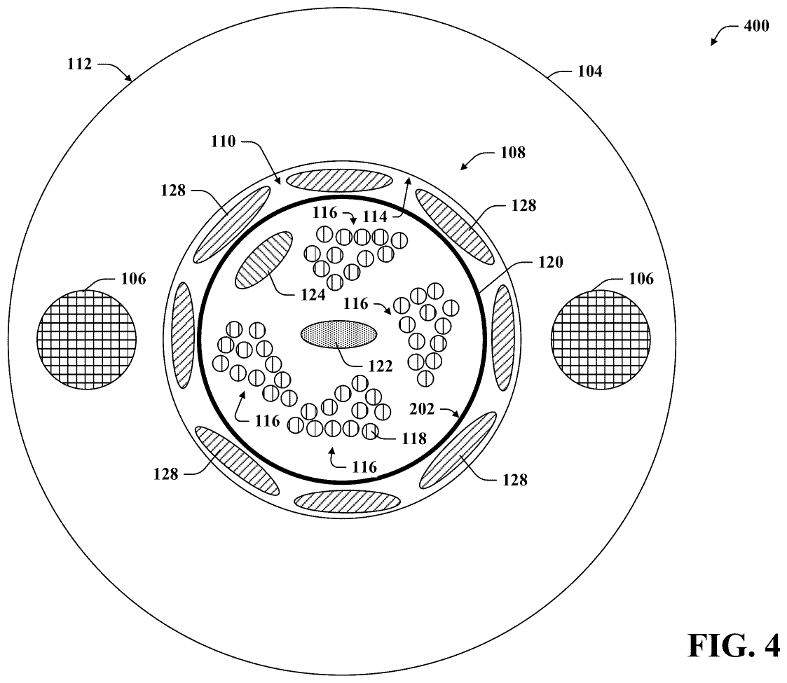

Referring now to FIG. 4, yet another exemplary optical fiber cable 400 is depicted. The optical fiber cable 400 is substantially similar to the optical fiber cable 300, but further includes the water-blocking yarns 122 within the TSU 120.

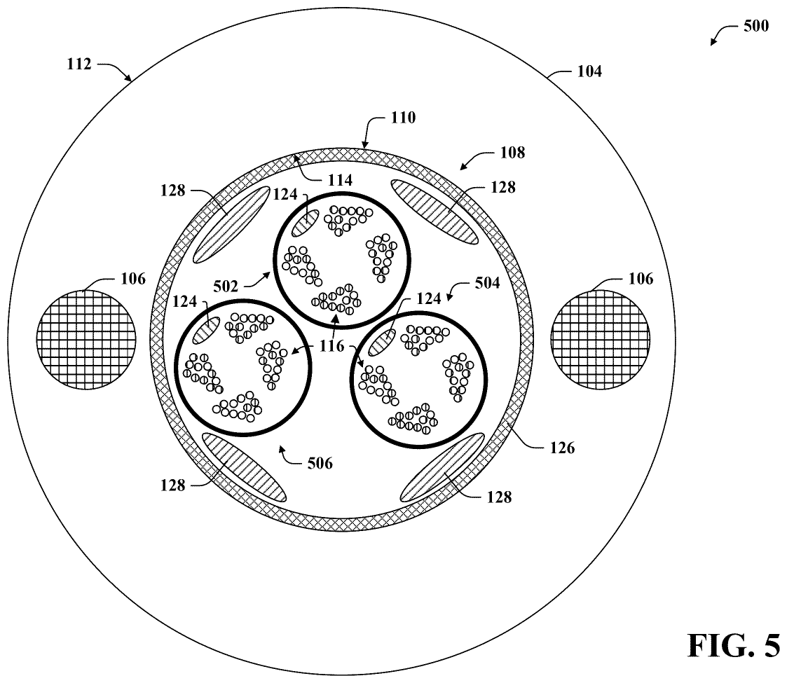

Referring now to FIG. 5, an exemplary optical fiber cable 500 is shown wherein the cable 500 includes a plurality of TSUs 502, 504, 506. The cable 500 includes the cable jacket 104, the embedded strength elements 106, the water-blocking tape 126, and strength elements 128. Each of the TSUs 502, 504, 506 includes one or more of the flexible optical fiber ribbons 116. As shown in FIG. 5, each of the TSUs 502, 504, 506 can further include a respective ripcord 124. The TSUs 502, 504, 506 can be independently routed by an installer in the field. For example, each of the TSUs 502, 504, 506 can be independently routed to a different respective location in a splice tray, allowing an installer to direct the ribbons 116 to different desired locations within the tray without risking snagging of the ribbons on features of the tray.

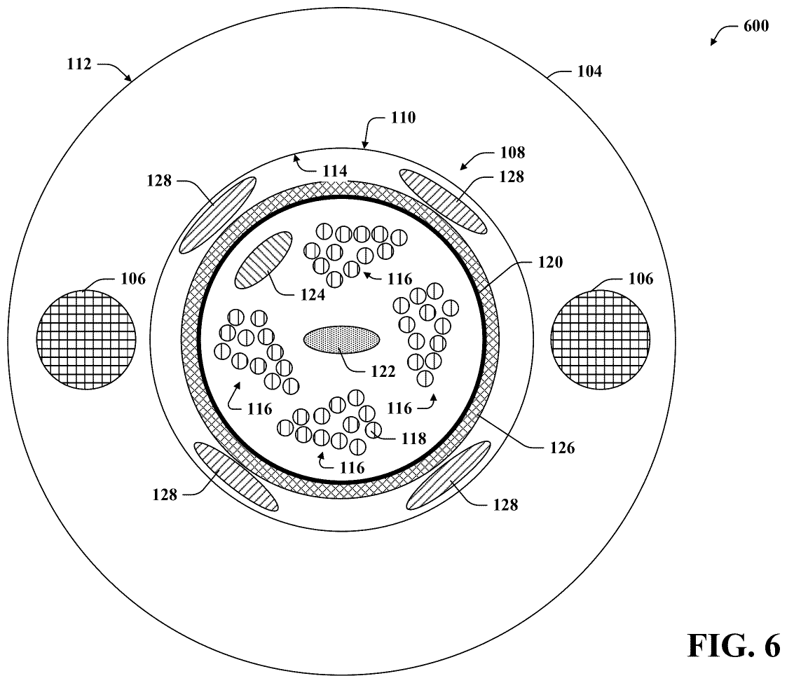

Referring now to FIG. 6, another exemplary cable 600 is illustrated, wherein the cable 600 is substantially similar to the cable 100, but has the additional strength elements 128 disposed between the water-blocking tape 126 and the jacket 104. Thus, the water-blocking tape 126 surrounds the TSU 120 but not the additional strength elements 128.

A thickness of the cable jacket 104 in any of the exemplary cables 100, 200, 300, 400, 500 can be varied to meet a burn test requirement for an intended application of the cables 100, 200, 300, 400, 500. In an example, the cable jacket 104 can have a wall thickness of 2.0 mm in order to pass burn test requirements of the UL 1666, UL 1685 and EN 50399 standards when a number of the optical fibers 118 is 144 fibers. In other examples, a wall thickness of the cable jacket 104 of 1.5 mm may be sufficient to pass the burn test requirements of the UL 1666, UL 1685 and EN 50399 standards when the number of the optical fibers 118 is 144 fibers. In still other examples, a wall thickness of the cable jacket 104 may be greater than or equal to 0.6 mm in order to pass the burn test requirements of the UL 1666, UL 1685 and EN 50399 standards when the number of the optical fibers 118 is 12 fibers.

An outside diameter of the cables 100, 200, 300, 400, 500 can be varied according to an intended application of the cables 100, 200, 300, 400, 500.

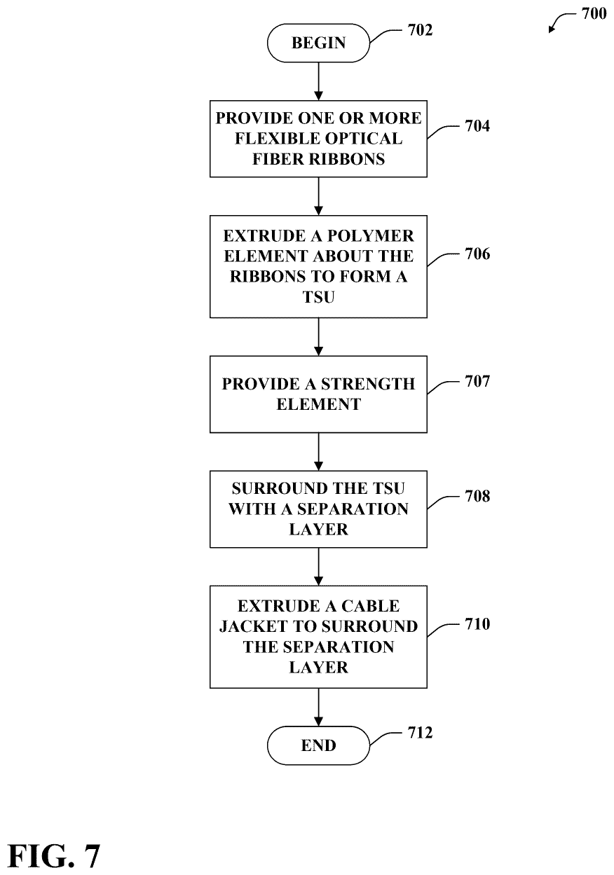

FIG. 7 illustrates an exemplary methodology 700 relating to forming an optical fiber cable. While the methodology 700 is shown and described as being a series of acts that are performed in a sequence, it is to be understood and appreciated that the methodology 700 is not limited by the order of the sequence. For example, some acts can occur in a different order than what is described herein. In addition, an act can occur concurrently with another act. Further, in some instances, not all acts may be required to implement the methodology 700 described herein.

The methodology 700 begins at 702 and at 704 one or more flexible optical fiber ribbons are provided. The flexible optical fiber ribbons can be advanced in a substantially linear direction for further processing in connection with forming an optical fiber cable. The flexible optical fiber ribbons can be advanced in the substantially linear direction in a substantially parallel manner. In other embodiments, the flexible optical fiber ribbons can be stranded prior to or during advancement of the ribbons in the substantially linear direction.

At 706, a polymer element is extruded about the ribbons to form a TSU. The polymer element can be, for example, an LLDPE tube that is extruded about the ribbons. Any of various additional materials can be included in the TSU. For example, a ripcord and/or a water-blocking yarn can be advanced in a parallel direction with the one or more ribbons, and at 706 the polymer element can be extruded about all of the ripcord, water-blocking yarn, and one or more ribbons. In some embodiments, a water-blocking material such as SAP powder can be embedded in or applied to an interior of the extruded polymer element during the process of extruding the polymer element.

At 707, a strength element is provided, wherein the strength element can be advanced in a substantially linear direction along with the TSU. In exemplary embodiments, the TSU can be formed in a first processing step, and the strength element and the TSU can later be advanced together (e.g., in parallel) in a substantially linear direction during a second processing step.

At 708, the TSU is surrounded with a separation layer (e.g., in the second processing step referenced above). In an exemplary embodiment, the separation comprises a water-blocking tape that surrounds the TSU. In other exemplary embodiments, the separation layer comprises a plurality of strength elements (e.g., tensile yarns such as aramid yarns) that are disposed around the TSU. In various exemplary embodiments one or more of the strength elements has a water-blocking material applied thereto. It is to be appreciated that in embodiments wherein the separation layer comprises a plurality of strength elements disposed around the TSU, steps 707 and 708 may be combined into a single step. In other words, the strength element provided at 707 can be one of a plurality of strength elements forming a separation layer at 708.

At 710, a cable jacket is extruded around the separation layer such that the cable jacket surrounds the TSU and the separation layer. The separation layer is disposed between the TSU and the cable jacket during the extrusion of the cable jacket 710 such that no portion of the TSU is in contact with the cable jacket during the extrusion of the cable jacket 710. Thus, the separation layer prevents tacking of the TSU to an interior surface of the cable jacket during extrusion of the cable jacket 710. In exemplary embodiments, the cable jacket is extruded at 710 such that at least one additional strength element (i.e., other than the strength element provided at 707) is embedded in the cable jacket. The methodology 700 ends at 712.

In accordance with other aspects of the present disclosure, conventional or yet-to-be developed optical connector or connectorization schemes may be used to provide pre-connectorized versions of cables 100, 200, 300, 400, 500, or 600, including, but not limited to, small (e.g., LC) and multi-fiber (e.g., MPO/MTP) connectors as commercially available. An LC connector may include a simplex design for a single optical fiber for transmission in a single direction (e.g., transmit or receive) or when a multiplex data signal is used for bi-directional communication over a single optical fiber. An LC connector may alternative use a duplex design including connection to a pair of optical fibers for separate transmit and receive communications are required between devices, for example.

An MPO (multi-fiber push on) connector is configured to multi-fiber groups including multiple sub-units of optical fibers, such as between 4 to 24 fibers. A type of MPO connector may be an MTP connector that may hold 12 fibers. In embodiments, the MPO connectors may hold 12 fibers, 24 fibers, 36 fibers, or 96 fibers, or another number as suitable per the design parameters for the pre-configured cables described herein.

What has been described above includes examples of one or more embodiments. It is, of course, not possible to describe every conceivable modification or alteration of the above systems, devices, or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An optical fiber cable, comprising:
a cable jacket extending longitudinally along a length of the cable, wherein the cable jacket surrounds a first interior region that extends along the length of the cable;
a first strength element embedded in the jacket and extending along the length of the cable;
a thin-film subunit (TSU) formed by an extruded polymer element that extends longitudinally along the length of the cable, the extruded polymer element enclosing a second interior region that extends along the length of the cable;
a flexible optical fiber ribbon comprising a plurality of intermittently-bonded optical fibers, the flexible optical fiber ribbon being disposed within the second interior region;
a second strength element extending along the length of the cable and disposed within the first interior region; and
a separation element disposed between the TSU and an interior surface of the cable jacket such that no portion of the TSU is in direct contact with the interior surface of the cable jacket.

2. The optical fiber cable of claim 1, further comprising a water-blocking element, the water-blocking element being disposed within the second interior region.

3. The optical fiber cable of claim 1, wherein the separation element comprises a water-blocking tape.

4. The optical fiber cable of claim 3, wherein the water-blocking tape is substantially conformal to the interior surface of the cable jacket.

5. The optical fiber cable of claim 1, wherein the second strength element comprises a fiberglass yarn.

6. The optical fiber cable of claim 1, wherein the second strength element comprises an aramid yarn.

7. The optical fiber cable of claim 1, wherein the separation element comprises a plurality of yarns surrounding the TSU.

8. The optical fiber cable of claim 1, further comprising a water-blocking powder embedded in or disposed on an interior surface of the extruded polymer element.

9. The optical fiber cable of claim 1, wherein the cable jacket comprises a polyethylene and wherein further the extruded polymer element comprises linear low density polyethylene (LLDPE).

10. The optical fiber cable of claim 1, wherein the TSU is a first TSU, wherein the cable comprises:
a plurality of TSUs disposed in the first interior region, the plurality of TSUS including the first TSU, wherein each of the plurality of TSUs defines a respective interior region having a respective flexible optical fiber ribbon disposed therein.

11. The optical fiber cable of claim 10, wherein a total number of optical fibers of the flexible optical fiber ribbons is greater than or equal to 12 and less than or equal to 288.

12. The optical fiber cable of claim 1, wherein the first strength element comprises a fiberglass yarn.

13. The optical fiber cable of claim 1, wherein the first strength element comprises a glass-reinforced plastic (GRP) rod.

14. The optical fiber cable of claim 1, wherein the extruded polymer element has a thickness of greater than or equal to 30 microns and less than or equal to 100 microns.

15. A method for forming an optical fiber cable, comprising:
providing one or more flexible optical fiber ribbons having a length;
extruding a polymer element about the one or more flexible optical fiber ribbons to form a thin-film subunit (TSU) that extends along the length of the one or more flexible optical fiber ribbons;
providing a strength element that extends along a length of the TSU but outside of the TSU;
surrounding the TSU with a separation layer; and
extruding a cable jacket to surround the separation layer, wherein the separation layer is disposed between the TSU and the cable jacket during the extruding of the cable jacket such that no portion of the TSU is in contact with the cable jacket during the extruding of the cable jacket, wherein further the cable jacket is extruded such that at least one additional strength element is embedded in the cable jacket.

16. The method of claim 15, wherein surrounding the TSU with the separation layer comprises surrounding the TSU with a water-blocking tape.

17. The method of claim 15, wherein surrounding the TSU with the separation layer comprises surrounding the TSU with a plurality of yarns.

18. The method of claim 15, wherein the polymer element is extruded such that the polymer element has a thickness of less than or equal to 100 microns.

19. An optical fiber cable, comprising:
an optical fiber ribbon comprising a plurality of optical fibers;
a binder formed around the optical fiber ribbon such that the optical fiber ribbon is disposed within the binder;
a tensile yarn disposed outside of the binder;
a water-blocking tape disposed around the binder and the tensile yarn; and
a cable jacket extruded around the water-blocking tape such that the water-blocking tape is disposed between the binder and an interior surface of the cable jacket, wherein the water-blocking tape is positioned such that the binder does not tack to the interior surface of the cable jacket during extrusion of the cable jacket.

20. The optical fiber cable of claim 19, wherein the binder comprises a binder yarn that contains the optical fiber ribbon.
